(19) United States
(12) Patent Application Publication
(10) Pub. No.: US 2026/0093409 A1
(43) Pub. Date: Apr. 2, 2026

(54) Replication Engine(s) For Preserving Discontiguous And Fragmented Compressed Data Units

(71) Applicant: NetApp, Inc., San Jose, CA (US)

(72) Inventors: Rupa Natarajan, Sunnyvale, CA (US); Venkateswarlu Tella, Bangalore (IN); Rachita Kothiyal, San Jose, CA (US); Santhosh Selvaraj, San Jose, CA (US); Wei Sun, Boulder, CO (US); Marshall Ronald Boser, Minneapolis, MN (US); Agnel Ravindran, San Jose, CA (US); Vatsalya Kunchakarra, Bothell, WA (US); Roopesh Chuggani, Jaipur (IN)

(73) Assignee: NetApp, Inc., San Jose, CA (US)

(21) Appl. No.: 18/903,280

(22) Filed: Oct. 1, 2024

(51) Int. Cl. G06F 3/06

(52) U.S. Cl. CPC G06F 3/065; G06F 3/061; G06F 3/064; G06F 3/067

(57) ABSTRACT

Various embodiments of the present technology generally relate to systems and methods for providing a replication engine for preserving discontiguous and fragmented compressed data extents (CDEs). In an aspect, a replication engine may determine a replication request to replicate one or more data blocks from a source storage system to a destination storage system. Based on the replication request, the replication engine may determine a first CDE containing the one or more data blocks. The replication engine may also determine a transfer map associated with the replication request. Based on the transfer map, the replication engine may determine a replication state associated with the one or more data blocks and initiate replication of the first CDE from the source storage system to the destination storage system based on the replication state associated with the one or more data blocks.

### TECHNICAL FIELD

Various embodiments of the present technology generally relate to distributed storage systems. More specifically, embodiments of the present technology relate to systems and methods for a replication engine for preserving discontinuous and/or fragmented compressed data units during replication within distributed storage systems.

### BACKGROUND

As businesses increasingly transition to cloud-based systems and infrastructure, data replication has become an essential tool for supporting high availability, disaster recovery, and data accessibility across geographically distributed environments. Data replication is the process of copying and maintaining data across multiple storage systems or locations to ensure consistency, availability, and redundancy. In the cloud, where data is often stored across multiple data centers, replication ensures that critical information is consistently available and protected from system failures or data loss. The growing reliance on cloud computing, coupled with the increasing scale and complexity of data workloads, makes efficient and reliable replication strategies more vital than ever.

To reduce the cost, time, and resource requirements for data replication, data is often compressed into smaller units. One common compression type is a compressed extent, such as a compressed data extent (CDE). A compressed extent refers to a unit of storage containing multiple data blocks that have been grouped and compressed together. Compressed extents are a critical tool in modern storage systems, allowing for optimization in both storage capacity and data transfer efficiency. In the context of data replication or transfer, compressed extents significantly reduce the amount of data that needs to be transferred between systems, minimizing bandwidth usage and accelerating the replication process. Since cloud-based environments often deal with large volumes of data across distributed systems, compressed extents ensure that replication can be performed quickly and cost-effectively. By maintaining the compression of data during transfer, systems can replicate more data with fewer resources, ensuring scalability without sacrificing performance.

While compressed extents offer significant storage and transfer efficiencies, certain replication or transfer processes struggle to preserve the compression savings they provide, especially when dealing with discontiguous or fragmented data blocks. In cases where data blocks that make up a compressed extents are scattered across non-adjacent locations within the storage system, the compression savings can be diminished. This fragmentation forces the replication process to handle the data blocks individually rather than as a single compressed extent, potentially leading to higher overhead in both processing time and bandwidth consumption. As a result, the compression benefits that compressed extents are designed to deliver may be lost both during replication and on the destination side where the data blocks may be stored in a decompressed format. This inefficiency can slow down replication, increase the amount of data transferred, bloating the storage requirements on the destination side, and reduce the overall performance benefits of using compressed extents.

Accordingly, there exists a need for improved enhanced and adaptive replication engine(s) that preserve compressed data units, such as compressed extents formed by discontiguous and/or fragmented data blocks, such as those provided herein.

The information provided in this section is presented as background information and serves only to assist in any understanding of the present disclosure. No determination has been made and no assertion is made as to whether any of the above might be applicable as prior art with regard to the present disclosure.

### Overview

Technology is disclosed herein for systems and techniques for providing a replication engine to preserve discontinuous and/or fragmented compressed data units during replication within a distributed storage system. In an example, the distributed storage system may include a source storage system and a destination storage system. At some point, a transfer process may be initiated to replicate data from the source storage system and the destination storage system. For example, a transfer request may be transmitted to the source storage system to initiate the transfer process. A replication engine, which may be part of storage controller that orchestrates the transfer process, may detect the transfer request. In some cases, the replication engine may receive a transfer response from the source storage system that identifies the data blocks to be replicated during the transfer process. Based on the data blocks, the replication engine may generate a transfer map that identifies a replication state for each of the data blocks.

When the transfer process is initiated, the replication engine may receive a replication request. The replication request may identify data blocks to be read and retrieved by the source storage system for replication to the destination storage system. From the replication request, the replication engine may determine whether the data blocks are associated with a CDE and whether the CDE is discontiguous or fragmented. In some cases, if the CDE is discontiguous or fragmented, the replication engine may determine a transfer map associated with the CDE or data blocks identified within the replication request.

Once the transfer map is identified, the replication engine may determine a replication state of the data blocks and based on the respective replication states, indicate or otherwise initiate replication of data blocks having unreplicated states. For data blocks that have replicated states, the replication engine may indicate that these data blocks be removed or otherwise filtered out of the replication request. If the replication engine receives a replication response from the destination storage system indicating that the data blocks within the replication request are successfully replicated, the replication engine may update the replication state of these data blocks within the transfer map to a replicated state. When the transfer process is completed, the replication engine may delete the transfer map.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

The accompanying drawings, which are incorporated into and constitute a part of this specification, illustrate one or more certain aspects and, together with the description of the example, serve to explain the principles and implementations of the certain examples.

FIG. 1 illustrates an example operational environment for a system for providing a replication engine, according to an embodiment herein.

FIG. 2 illustrates an example distributed storage system containing a replication engine, according to an embodiment herein.

FIG. 3 illustrates an example process for providing a replication engine, according to an embodiment herein.

FIG. 4 illustrates an example flow for providing a replication engine during a transfer process, according to an embodiment herein.

FIG. 5 illustrates an example flow in which a transfer interruption occurs during the replication process, according to an embodiment herein.

FIG. 6 illustrates an example process for handling free data blocks within a CDE, according to an embodiment herein.

FIG. 7 shows an example computing device suitable for providing one or more steps of a replication engine process, according to an embodiment herein.

Some components or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

In the modern era, the escalating generation and consumption of data have necessitated the adoption of advanced storage solutions, leading to an increased reliance on distributed, cloud-based or hybrid storage systems. To support high availability, disaster recovery, and data accessibility across geographically distributed environments, these storage systems often employ data replication to copy and maintain data across multiple storage systems or locations to ensure data consistency, availability, and redundancy. As reliance on cloud computing and complexity of data workloads increasingly grow, efficient and reliable replication becomes more vital than ever.

To accommodate the increasing volume of data being replicated and stored in modern systems, compressed extents, such as Compressed Data Extents (CDEs) have become a key tool for enhancing efficiency. A compressed extent is a logical unit of storage composed of multiple data blocks that are grouped together and compressed into a single extent. This compression reduces the overall size of the data, offering several advantages in data replication and transfer. By significantly decreasing the amount of data that needs to be moved between systems, compressed extents help to minimize bandwidth usage, reduce latency, and accelerate the overall replication process. Furthermore, since compressed extents are transferred in their compressed form, the destination system can store the data exactly as received, thus preserving the compression benefits even after replication. This not only lowers the storage requirements on the destination side but also optimizes the system's resource utilization. By enabling more efficient use of bandwidth and storage, compressed extents play a critical role in ensuring scalability and performance in cloud-based and large-scale distributed environments. For case of explanation, the following focuses on CDEs, but it should be appreciated that discussion is equally applicable to other types of compressed extents.

While CDEs offer significant storage and transfer efficiencies, certain replication or transfer processes struggle to preserve the compression savings, particularly when dealing with discontiguous or fragmented data blocks. That is, systems often decompress the CDE and transfer the data blocks individually in the decompressed form. Discontiguous data blocks refer to blocks that are stored in non-adjacent locations within the storage system, meaning the blocks that make up a CDE are scattered rather than sequentially arranged. Fragmented data blocks occur when available storage space is fragmented, causing data to be distributed across different physical or logical areas of the storage system. For example, in a CDE composed of blocks with Virtual Volume Block Numbers (VVBNs) 100, 101, 105, and 108, the gaps between these block numbers indicate discontiguity. It should be appreciated that while the discussion herein uses VVBNs, other block identifiers may be used to identify data blocks, such as FFBNs (File FlexBlock Numbers).

In such cases, the compression savings of the CDE can be diminished. When blocks are discontiguous, the replication process often must decompress the CDE and handle the data blocks individually, rather than as a cohesive, compressed extent. This fragmentation increases overhead in both processing time and bandwidth usage, as the system can no longer efficiently transfer the entire compressed extent in a single operation. As a result, the benefits CDEs are designed to deliver—such as reduced data size and faster transfers—can be lost during replication and storage. As those skilled in the art readily appreciate, replicating decompressed data significantly increases the amount of data that needs to be transferred, resulting in higher bandwidth consumption and longer transfer times. Additionally, replicating uncompressed data places greater storage demands on the destination system, reducing the overall efficiency of both the replication process and storage resource utilization. Accordingly, traditional systems and techniques which are unable to preserve CDEs formed from discontiguous and/or fragmented data blocks often lead to increased costs and slower performance, especially in large-scale or cloud-based environments.

To address the shortcomings of traditional systems and techniques, an example replication engine is provided herein. In particular, unlike traditional systems, the replication engine described herein preserves CDEs formed from discontiguous and/or fragmented data blocks, and thus preserves the replication and storage benefits provided by CDEs. As will be expanded on below, when a transfer request, such as Snap Diff request, is identified, the replication engine may initiate a transfer map. The replication engine may determine the data blocks to be replicated during the transfer request and generate the transfer map to indicate a replication state for the data blocks. As a replication request, such as a Snap Read request, is generated to retrieve a specific range of data blocks identified in the transfer request, the replication engine may first check with the transfer map to determine whether or not a respective data block has been already replicated. It should be appreciated that while the following discussion focuses on Logical Replication Stream Extent (LRSE) transfers, in particular a Snap Diff process for case of explanation, other replication processes are contemplated herein.

When a data block is identified to be replicated per a replication request, if the replication engine determines that the data block has an unreplicated status, the replication engine may indicate that the CDE that the data block is part of should be replicated from a source storage system to a destination storage system. The CDE may contain data blocks that are not part of the current replication request, however, to preserve the compression benefits the CDE may be replicated in compressed form. This means that the other data blocks may be replicated to the destination storage system. Once the CDE is replicated, the replication engine may update the transfer map to reflect that all the data blocks that are part of the CDE are in a replicated state. As such, if a subsequent replication request is generated for the other data blocks in the already replicated CDE, the replication engine may determine that these data blocks have a replicated state and remove these data blocks from the subsequent replication request.

By preserving discontiguous and fragmented CDEs during replication and at the destination storage system, the replication engine provides several benefits over traditional approaches. First, by maintaining data in its compressed form throughout the replication process, the replication engine provides significant bandwidth savings, as smaller amounts of data are transferred between systems. This results in faster replication times and reduced network congestion, especially in environments with limited bandwidth. At the destination storage system, the replication engine ensures that the data blocks are received in compressed form, thereby allow the destination storage system to store the CDEs as received without requiring an additional compression step or storing the data in uncompressed form, thereby reducing the amount of physical storage required. In other words, the replication engine allows for more efficient use of storage resources, enabling the system to handle larger datasets without requiring additional capacity. Additionally, by preserving CDEs the replication engine minimizes the processing overhead typically associated with decompressing and recompressing data, improving overall system performance and reducing latency. In cloud-based or distributed environments, these efficiencies translate into lower operational costs, better scalability, and improved data availability.

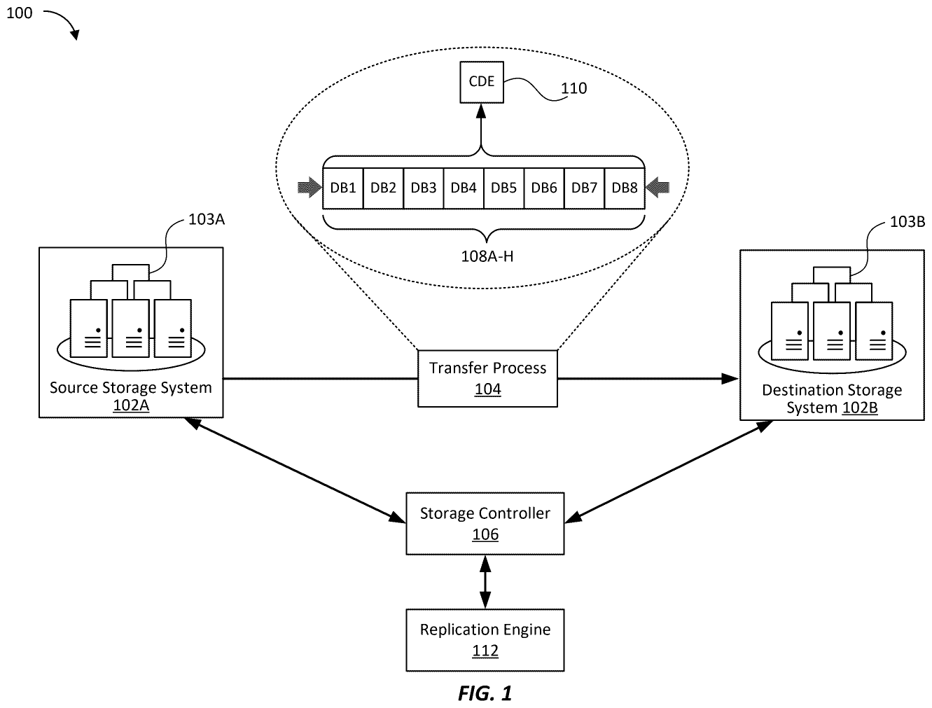

Turning now to the Figures, FIG. 1 illustrates an example operational environment for a system 100 for providing a replication engine 112, according to an embodiment herein. As shown, the system 100 may include a source storage system 102A and a destination storage system 102B between which data may be replicated or transferred via a transfer process 104. The storage systems 102A-B can be implemented in various configurations, including on-premises, cloud-based, or hybrid systems, depending on the needs of a respective organization. As those skilled in the art appreciate, on-premises systems involve physical storage hardware located at the company's site, providing direct control and security over data. Cloud-based systems, on the other hand, leverage remote servers managed by third-party providers, offering scalability and flexibility while reducing the need for in-house infrastructure. And hybrid systems combine both on-premises and cloud components, allowing businesses to balance control and scalability by storing critical data locally while using the cloud for additional storage capacity or redundancy.

Each of these systems 102A-B may contain one or more resources 103A-B, respectively, which may include storage devices like hard drives or SSDs, processing units for managing data operations, and network interfaces to facilitate data transfer between different locations. In a cloud environment, resources may also encompass virtualized storage and compute resources 103A-B provisioned dynamically to meet demand. In the cases, where the storage systems 102A-B are distributed in a hybrid environment, each of the storage systems 102A-B may span multiple geographic locations, allowing for high availability, disaster recovery, and data replication across different regions, ensuring that data remains accessible and secure even in the event of localized failures.

To ensure data availability, consistency, and redundancy, data may be replicated from the source storage system 102A to the destination storage system 102B. To facilitate data replication, such as via the transfer process 104, the system 100 may include a storage controller 106. The storage controller 106 may manage and orchestrate data replication between the storage systems 102A-B by acting as the intermediary between the source and destination storage systems 102A-B. As such, the storage controller 106 may oversee the movement of data, ensuring consistency, and handling any errors or disruptions that may occur during the transfer process 104.

In examples where the transfer process 104 is a LRSE process, the storage controller 106 may manage critical tasks such as issuing Snap Diff requests to identify changes between snapshots, sending Snap Read requests, and coordinating the transfer of data from the source storage system 102A to the destination storage system 102B. The storage controller 106 may optimize the replication by ensuring only the modified or new data is transmitted, reducing bandwidth usage and speeding up the process. Additionally, the storage controller 106 may monitor the system 100 performance, handle network communication, and apply policies such as deduplication or compression to further improve efficiency. By managing these complex interactions, the storage controller 106 plays a pivotal role in ensuring that data replication is both reliable and efficient, whether the storage systems 102A-B are on-premises, cloud-based, or part of a hybrid architecture.

In an embodiment, the transfer process 104 may be a Snap Diff process in which the storage controller 106 identifies changes between two snapshots taken at different points in time on the source storage system 102A. The storage controller 106 may initiate the transfer process 104 by sending a transfer request, such as a Snap Diff request to the source storage system 102A. The transfer request may ask for a comparison between the current snapshot of the source storage system 102A and a previous snapshot, identifying one or more data blocks that have been added, modified, or deleted since the last replication. Once the Snap Diff operation is complete, the source storage system 102A may respond with a list of the changed data blocks, often identified by their VVBNs.

As those skilled in the art readily appreciate, a VVBN is a unique identifier assigned to individual data blocks within a virtualized storage environment, such as the system 100. In the storage system 102A-B, data is divided into blocks, which are the smallest units of data that can be individually addressed and managed. Each block within a volume is given a VVBN, which serves as its address within the virtual volume, allowing the storage system 102A-B to locate, access, and manage the block efficiently. VVBNs are particularly important in systems that support features like snapshotting and data replication, as they enable the precise tracking of which blocks have been modified or accessed. This granular level of control is crucial in processes such as the Snap Diff operation, where the system 100 identifies changes at the block level and uses the VVBNs to manage the replication or restoration of data.

After receiving the list of changed blocks, the storage controller 106 may proceed by issuing replication requests, such as Snap Read requests to the source storage system 102A for the specific data blocks that need to be transferred. In systems utilizing Compressed Data Extents (CDEs), such as illustrated CDE 110, the storage controller 106 may retrieve the compressed units of data rather than individual blocks, ensuring that the compression savings are maintained during the transfer. For example, as illustrated, the CDE 110 may be formed by compressing multiple data blocks (DB1-8) 108A-H, each of which has a corresponding VVBN. By compressing the data blocks 108A-H into the CDE 110, the bandwidth required to transmit and replicate the CDE 110 may be less than the bandwidth required to individually transmit and store the data blocks 108A-H. It should be appreciated that while only the CDE 110 is illustrated for the transfer process 104, a typical replication or transfer process may include multiple CDEs ranging in size. For example, Snap Diff operation may include hundreds, if not thousands of CDEs 110.

The CDE 110 may range in size depending on the system's 100 architecture and the chosen compression strategy. Common examples of the CDE 110 may include an 8K CDE or a 32K CDE, where the number denotes the size of the compressed data extent. An 8K CDE typically compresses a smaller group of data blocks, such as 2 blocks of 4 KB size, while a 32K CDE compresses a larger set, often encompassing 8 blocks 108A-H of 4 KB size. As noted above, the CDE 110 is designed to optimize both storage and transmission efficiency by reducing the amount of data that needs to be stored or transferred between systems 102A-B. During transmission, the CDE 110 saves bandwidth by minimizing the size of the data being sent over the network, allowing more data to be transferred in less time and reducing the load on network resources. Similarly, when stored, the CDE 110 takes up less physical space on the respective storage medium within the storage systems 102A-B, enabling more data to be stored within the same capacity, which is particularly beneficial in environments where storage efficiency is critical.

Responsive to receiving the replication requests (e.g., Snap Read messages), the source storage system 102A may respond with the actual data, either as individual blocks 108A-H or the CDE 110, which the storage controller 106 forwards to the destination storage system 102B. The storage controller 106 may manage the entire transfer process 104, ensuring that the data is transferred efficiently, that the integrity of the data is preserved, and that any failures or disruptions in the process are handled, such as by retrying failed transfers or handling aborted sessions. Once the transfer process 104 is complete, the destination system 102B stores the data in the same compressed format, minimizing storage overhead and ensuring consistency between the two systems 102A-B.

Under conventional replication approaches, for the storage controller 106 to effectively preserve the CDE 110 when requesting the replication of one or more data blocks 108A-H within the CDE 110, two key conditions be met. First, the CDE 110 must be formed from contiguous VVBNs, meaning that the data blocks 108A-H are sequentially arranged within the source storage system 102A, and thus allow the data blocks 108A-H to be compressed together into a single, cohesive extent (e.g., CDE 110). Second, all the VVBNs of the data blocks 108A-H within the CDE 110 must be read as part of the same Snap Read operation on the source side. Conventional replication approaches require a single operation to read all the data blocks 108A-H to capture the data in its entirety and maintain its compressed form during replication. Under conventional approaches this is important because if the VVBNs were read separately, the system 100 might have to decompress and then recompress the data, which would negate the bandwidth and storage savings that CDEs provide.

When the two conditions—contiguity of VVBNs and reading all VVBNs within the same Snap Read operation—are not met for data blocks 108A-H within a respective CDE 110, several inefficiencies can arise. If the data blocks 108A-H that make up the CDE 110 are not contiguous, meaning they are scattered across different locations within the source storage system 102A, the compression savings are compromised. That is, in such cases, the storage controller 106 may be forced to handle each block 108A-H individually rather than as a single, cohesive extent, leading to the decompression of the CDE 110 during the transfer process 104. Another scenario may involve when the VVBNs associated with the data blocks 108A-H within the CDE 110 are not read in a single Snap Read operation, the system 100 may have to process multiple read requests, potentially leading to fragmented data being transferred. When the fragmented data is received by the destination storage system 102B, the destination storage system 102B may decompress the CDE 110 because it does not identify all the data blocks 108A-D within the transfer. Table 1 provided below illustrates various scenarios and CDE types and how they are processed by conventional systems, including when conventional approaches require decompression of the CDE 110.

TABLE 1

| | | | On-Wire | Destination |
|---|---|---|---|---|
| CDE Type | Explanation | Source Behavior | Preservation | Behavior |
| Contiguous CDE | CDE formed V1- | Read as | Yes | CDE is |
| read in same | V8 is read in same | compressed and | | preserved |
| replication request | Snap Read | no decompression | | |
| Contiguous CDE | CDE is formed | Read as packed | No | CDE is not |
| read in different | V1-V8 but only | but decompressed | | preserved. |
| replication requests | V1-V4 is read in | to send | | |
| | one Snap Read | | | |
| Discontiguous CDE | CDE formed from | Read as packed | Yes | CDE is not |
| in same replication | V0, V2, V4, V6, | and no | | preserved as |
| request | V8, V10, V12, and | decompression | | destination |
| | V14 and read in | | | writes as |
| | same Snap Read | | | uncompressed |
| | and in same order | | | |
| Out of order read | CDE is formed | Read as packed | No | Written as |
| CDE | from V2, V1, V4, | but decompressed | | uncompressed |
| | V3, V5, V6-V8 | because read order | | |
| | but read happens | of VVBNs is not | | |
| | in different order | the order of the | | |
| | | CDE | | |
| Fragmented CDE | CDE is formed | Read as packed | No | Written as |
| | V1-V8 but V1, V2 | but decompressed | | decompressed |
| | are freed; read is | because all VVNs | | |
| | for V3-V8 | aren't seen in | | |
| | | transfer | | |
| Partial CDE | CDE is formed | Read as packed | No | Written as |
| | V1-V4 but V1, V4 | but decompressed | | decompressed |
| | are in snapshot s1 | because all VVNs | | |
| | and V5-V6 are in | aren't seen in | | |
| | snapshot s2; V1- | transfer | | |
| | V4 are read during | | | |
| | s1. | | | |

Under conventional replication approaches, when the two conditions for preserving CDEs are not met—namely, the contiguity of VVBNs and the unified Snap Read operation—the system 100 is forced to decompress the CDEs, leading to several detrimental consequences. First, the CPU cost on the source storage system 102A increases significantly, as decompression is a resource-intensive process that demands substantial computational power. This additional load can slow down overall system performance and reduce the efficiency of the source storage system 102A. Second, the network experiences bloat due to the transfer of uncompressed data, which consumes significantly more bandwidth than compressed data, leading to slower transfer speeds and potential congestion on the network. Third, on the destination storage system 102B, the uncompressed data results in storage bloat, as more physical space is required to store the same amount of data compared to its compressed form.

Furthermore, once the uncompressed data is transferred, additional CPU resources are required for background processing to recompress this data, if performed, on the destination side. This recompression not only adds to the computational burden but also delays the availability of the data for use. Additionally, during the period between writing the uncompressed data and its subsequent recompression, extra storage provisioning may be needed to accommodate the increased space requirements, leading to inefficient use of storage resources 103A-B and potentially requiring costly expansions to the storage infrastructure. These compounded effects highlight the critical importance of maintaining CDEs throughout the replication process to avoid these costly and resource-intensive consequences.

To preserve the CDE 110, regardless of whether the two conditions are met, the storage controller 106 may be in operational communication with the replication engine 112. Although the replication engine 112 is illustrated as separate from the storage controller 106, in some embodiments, the replication engine 112 may be part of the storage controller 106. As will be described in greater detail below, the replication engine 112 may communicate with the storage controller 106 to identify when a transfer request is initiated, such as when a Snap Diff request is sent to the source storage system 102A. Based on the response from the source storage system 102A, the replication engine 112 may generate a transfer map that tracks the replication state for each data block 108A-H (or rather VVBN) identified during the Snap Diff operation.

As the storage controller 106 generates replication requests based on the Snap Diff operation, the replication engine 112 may monitor which data blocks 108A-H (based on VVBNs) are being requested, and notify the storage controller 106 whether or not a respective data block 108A-H has been previously replicated during the transfer process 104. For example, if the replication request is for data blocks 108A-D based on their respective VVBNs, and these transfer map indicates that these VVBNs have an unreplicated state, then the replication engine 112 may indicate or instruct the storage controller 106 to replicate the CDE 110. Once the CDE 110 is replicated, the replication engine 112 may update the transfer map to indicate that the data blocks 108A-H have a replicated state. Since the CDE 110 includes the data blocks 108A-H, if any of the data blocks 108E-H are requested in a subsequent replication request, the replication engine 112 may indicate or instruct the storage controller 106 to remove these data blocks 108E-H from the subsequent replication request as they are already replicated.

Since the CDE 110 is replicated in compressed form, the replication engine 112 ensures that the benefits of the CDE are preserved through the transfer process 104. For example, by keeping the CDE 110 intact, the replication engine 112 minimizes the CPU cost on the source storage system 102A by avoiding the resource-intensive task of decompressing, thereby enhancing the overall performance of the system 102A. On the destination storage system 102B side, the replication engine 112 prevents storage bloat, as the data remains compressed, requiring less physical space and thus optimizing storage utilization. Moreover, the replication engine 112 eliminates the need for additional CPU resources to recompress the data post-transfer, ensuring that the data is immediately available for use without the delay or overhead associated with background processing.

The replication engine 112 also prevents network bloat and increased bandwidth required for transmitting decompressed data. Additionally, by tracking what data blocks 108A-H have been previously replicated, the replication engine 112 ensures that data blocks 108A-H are only replicated once across the wire, thereby further reducing network bloat. Overall, the replication engine 112 reduces resource consumption, and ensures that storage and network capacities are used to their fullest potential, making the entire data replication process more efficient and cost-effective over conventional approaches.

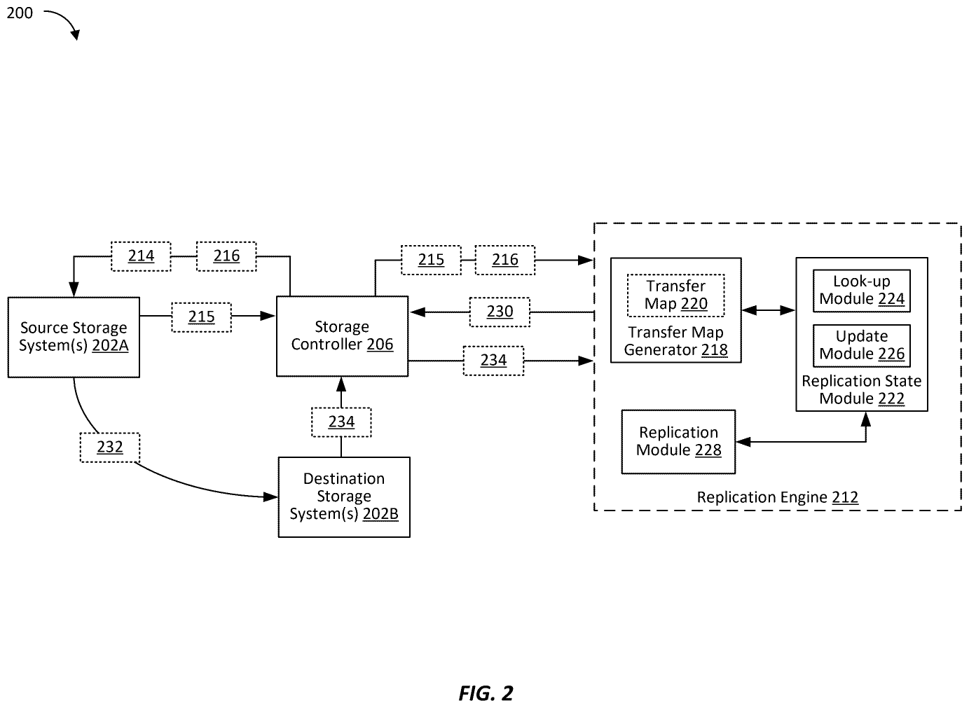

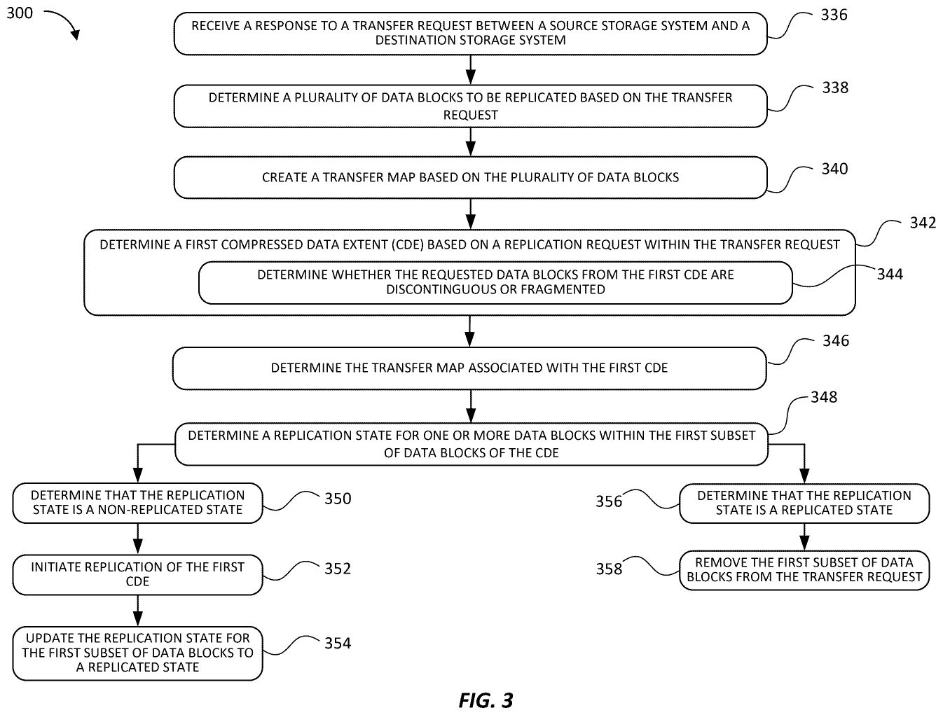

Turning now to FIG. 2, an example distributed storage system 200 containing a replication engine 212 is illustrated, according to an embodiment herein. For case of illustration, FIG. 2 is described with reference to FIG. 3. FIG. 3 provides a process 300 for providing a replication engine, such as the replication engine 212, according to an embodiment herein. While the process 300 is described with respect to FIG. 2, it should be appreciated that it is equally applicable to other systems and components provided herein. Additionally, while the process 300 illustrates steps 336-358, the process 300 is not limited to these steps and may include additional steps or may lack one or more of these steps. That is, the steps 336-358 illustrate an example process for providing the replication engine, according to an example embodiment.

As illustrated, the system 200, which may be the same or similar to the system 100, may include a storage controller 206 that is in operable communication with a source storage system 202A and a destination storage system 202B, which may be the same or similar the storage controller 106, the source storage system 102A, and the destination storage system 102B, respectively. As noted above, the storage controller 106 may manage and orchestrate replication of data between the source storage system 202A and the destination storage system 202B.

To initiate replication of data, such as to initiate the transfer process 104, the storage controller 206 may transmit a transfer request 214 to the source storage system 202A. For example, the transfer request 214 may be a Snap Diff request. Responsive to the transfer request 214, the source storage system 202A may identify one or more data blocks that have been added, modified, or deleted since the last replication, such as by performing a current snapshot of the data and comparing it to a previous snapshot. This comparison may be referred to herein as a Snap Diff operation. Once the Snap Diff operation is complete, the source storage system 202A may provide a response 215 to the transfer request 114 which includes a list of the changed data blocks. The list may identify the changed data blocks by their respective VVBNs.

After the storage controller 206 initiates the transfer process (e.g., Snap Diff operation), the storage controller 206 may provide the response 215 to the replication engine 212 (336). Based on the response 215, the replication engine 212 may determine the data blocks to be replicated during the transfer process (338).

Responsive to receiving the response 215, the replication engine 212 may generate a transfer map 220 for the respective transfer process (340). In particular, the replication engine 212 may include a transfer map generator 218 that generates the transfer map 220 based on the data blocks identified in the response 215. The transfer map 220 may monitor the replication state or status for each data block identified in the response 215, as will be described in greater detail below. In some embodiments, the transfer map 220 may be a persistent map that is stored for the duration of a respective transfer. For example, the replication engine 212 may store the transfer map 220 in permanent memory, such as writing the transfer map 220 to disk.

In some embodiments, the transfer map 220 may be a bitmap that represents the replication state for a respective VVBN (e.g., data block) by a binary value or digit. For example, the transfer map 220 may indicate that a VVBN having an unreplicated state as a zero (0), while indicating that a VVBN having a replicated state as a one (1). In such cases, because the transfer map 220 is a bit map, the transfer map 220 may be dense, requiring minimal space for storage. For example, the transfer map 220 may use one bit for each VVBN, meaning that for transfer request of a terabyte (TB) volume, the transfer map 220 could hold 268435456 VVBNs. Such a transfer map 220 may require only 32 megabytes (MB) of space.

In an embodiment, the transfer map 220 may be a flat bitmap file that is indexed by VVBN. Below is an example format for the transfer map 220 generated for a LSRE replication process performed within a WAFL (Write Anywhere File Layout) file system:

```
  typedef unsigned long
  repl_xfermap_ent;
    #define BLOCK_SIZE 4096
  typedef struct
  repl_xfermap_Block_hdr {
      unsigned long magic;
      unsigned long fbn_low;
      unsigned long fbn_high;
      unsigned long spares;
    } repl_xfermap_Block_hdr;
    #define REPL_XFERMAP_BLK_ENTS
    ((BLOCK_SIZE − sizeof (repl_xfermap_Block_hdr)) / sizeof
(repl_xfermap_ent))
    typedef struct repl_xfermap_blk {
    repl_xfermap_Block_hdr h;
    repl_xfermap_ent e[REPL_XFERMAP_BLK_ENTS];
    } repl_xfermap_blk;
```

Responsive to receiving the response 215 from the source storage system 202A identifying data blocks for replication, the storage controller 206 may initiate one or more replication requests 216. In the context of a LRSE transfer, the replication requests 216 may be or include a Snap Read request for capturing or collecting the data blocks to be replicated. However, prior to sending a replication request 216 to the source storage system 202A the storage controller 206 may provide the replication request 216 to the replication engine 212.

Upon receiving the replication request 216, the replication engine 212 may determine a first CDE, such as the CDE 110, within the replication request 216 (342). For example, the replication request 216 may include a request for data blocks 108A-C, which for ease of illustration may correspond to VVBNs V2-V4. Based on the requesting VVBNs, the replication engine 212 may determine that these VVBNs are part of the CDE 110. In some embodiments, the replication engine 210 may read the metadata associated with the CDE 110, such as the CDE header, to determine what VVBNs form the CDE 110, as some VVBNs may not be candidates for replication in a respective transfer.

In some embodiments, the replication engine 210 may determine whether the requested data blocks within the CDE 110 are contiguous, discontiguous, or fragmented (344). For example, the replication engine 210 may determine metadata associated with the CDE 110, such as the CDE header, to determine whether the data blocks forming the CDE 110 are contiguous or discontiguous, and what data blocks form the CDE 110 overall. If the replication engine 210 determines that the CDE 110 is contiguous and that the replication request 216 is for all of the data blocks within the CDE 110, then the replication engine 210 may indicate, such as by sending the indication 230, that the storage controller 206 should proceed with replicating the respective CDE 110. For example, if the replication engine 210 determines that the replication request 216 is for all of the data blocks 108A-H (e.g., requested in a single operation) and the CDE 110 is contiguous, then the replication engine 212 may indicate that the storage controller 106 should proceed with the replication request 216.

However, if the replication engine 212 determines that the CDE 110 is discontinuous or that the replication request 216 requests only a subset of the data blocks forming the CDE 110, then the replication engine 212 may determine a transfer map associated with the replication request 216 and/or CDE 110 (346). As can be appreciated, the storage controller 206 may be managing multiple transfer processes at a given time, and as such, the replication engine 212 may contain multiple transfer maps 220. As such, when the replication request 216 is received from the storage controller 206, the replication engine 212 may first determine which transfer map 220 is associated with the replication request 216. In some cases, determining which replication request 216 is associated with a respective transfer map 220 may be done based on the CDE 110 associated with the VVBNs identified within the replication request 216.

Once the replication engine 212 determines the transfer map 220 associated with the replication request 216, the replication engine 212 may determine the replication state for the requested data blocks (348). In particular, the replication engine 212 may include a replication state module 222 containing a lookup module 224. The lookup module 224 may perform a lookup on the transfer map 220 based on the VVBNs identified in the replication request 216 and determine the replication state for the respective VVBNs. Based on the replication state, the replication engine 212 may notify the storage controller 206 whether or not to include the VVBNs and/or respective CDEs 110 in the replication request 216. The following discussion will first focus on cases where the transfer map 220 indicates an unreplicated state and then discuss cases where the transfer map 220 indicates a replicated state.

Following the above example where the replication request 216 is for the data blocks 108A-C, lookup module 224 may perform a lookup on the transfer map 220 for the data blocks 108A-C based on their respective VVBNs. From the transfer map 220, the replication engine 212 may determine that at least one of the respective data blocks 108A-C has an unreplicated state (350). Based on this unreplicated state, the replication engine 212 may generate and provide an indication 230 of the unreplicated state of the data blocks 108A-C to the storage controller 206 to initiate replication of the CDE 110 (352). For example, the replication engine 212 may include a replication module 228 that generates the indication 230 to include a notification or otherwise instruct the storage controller 206 to replicate the CDE 110, even though the replication request 216 was only for the data blocks 108A-C. It is noted that a replication check is not made for blocks 108D-H, as those blocks 108D-H will be replicated even if the data blocks 108D-H have already been replicated. The improved efficiency of transferring the CDE 110 outweighs the duplicative writing of the data blocks 108D-H and overwriting the replication state for those data blocks 108D-H. Responsive to receiving the indication 230, the storage controller 206 may send the replication request 216 to the source storage system 202A. In some cases, the storage controller 206 may update the replication request 216 to request the CDE 110 in place of the request for only the data blocks 108A-C to ensure preservation of the compressed data.

Once the source storage system 102A receives the replication request 216, which may include a Snap Read request, it may initiate the process of capturing and providing the requested data, such as the CDE 110. The source storage system 102A may first locate the relevant CDE 110 within its storage, ensuring that the data blocks 108A-H are up-to-date and consistent with the most recent snapshot. Once located, the source storage system 102A then transmits the replicated data 232 (e.g., the CDE 110) to the destination storage system 102B. During this transmission, the data remains compressed, preserving the bandwidth savings and minimizing network load. Upon receipt, the destination storage system 102B may store the CDE 110 in its compressed form, maintaining the storage efficiency and ensuring that the replicated data is ready for use with minimal processing overhead.

If the replicated data 232 is successfully received and written on the destination side, then the destination storage system 202B may generate and send a replication response 234 to the storage controller 206 confirming that the transmission was successful. The replication response 234 may serve as an acknowledgment that the data was accurately transferred, properly stored in the destination storage system 202B, and that the CDE 110 (or other data) has been integrated into the destination storage system 202B without errors. This confirmation allows the storage controller 206 to proceed with any subsequent steps in the replication process, such as releasing resources or initiating further replication tasks if needed.

The replication response 234 may be provided to the replication engine 212, such as via the storage controller 206. Responsive to receiving the replication response 234, the replication engine 212 may update the replication states for the data blocks 108A-H of the CDE 110 within the transfer map 220 to a replicated state (354). In particular, an update module 226 within the replication state module 222 may update the respective replication state for the data blocks 108A-H to indicate a replicated state. As can be appreciated, by waiting until the replication response 234 is received to update the transfer map 220, the replication engine 212 ensures that the CDE 110 is successfully replicated before indicated it as such. This may ensure that any replicated data 232 that fails to be successfully replicated, such as due to an abort or controller failure, maintain an unreplicated state within the transfer map 220. This can allow the replication engine 212 to notify the storage controller 206 to resend any unsuccessful replication requests and prevent corruption of the data.

In scenarios where upon lookup on the transfer map 220, the replication engine 212 determines that all of the data blocks 108A-C are replicated (e.g., have a replicated state) (356), the replication engine 210 may notify the storage controller 206 to remove the data blocks 108A-C from the replication request 216 (356). For example, the replication module 228 may generate the notification 230 identifying the data blocks 108A-C as replicated and notify or otherwise instruct the storage controller 206 to filter out or remove the VVBNs associated with the data blocks 108A-C from the replication request 216. Responsive to receiving the notification 230, the storage controller 206 may modify or otherwise update the replication request 216 to remove the data blocks 108A-C from the replication request 216.

As noted above, in some cases, the replicated data 232 may not successfully be read and/or written by the storage systems 102A-B, respectively. In such cases, the replication response 234 may not be generated and provided by the destination storage system 102B. In such cases, the storage controller 206 may coordinate with the replication engine 212 to reissue the replication request 216 for the respective data. For aborted transfers, either due to error or manual aborts, the replication engine 212 may truncate the transfer map 220 as part of the abort operation. That is, the replication engine 212 may truncate the transfer map 220 to reflect only the data that has been successfully transferred up to the point of the abort. When the replication engine 212 truncates the transfer map 220, it may effectively discard any remaining portions of the transfer map 220 that correspond to data blocks that were not transferred before the operation was aborted. This ensures that the transfer map 220 only includes the data that was successfully replicated, allowing for a clean and accurate state of the transfer process. In embodiments, where the abort is unplanned, the replication engine 212 may keep the transfer map 220 until the transfer restarts again.

When the transfer process is completed, the storage controller 206 may notify the replication engine 212 of its completion. Responsive to this notification, the replication engine 212 may delete the transfer map 220. For example, the replication engine 212 may delete or erase the transfer map 220 from persistent memory.

In alternate embodiment, the storge controller 206 may not provide the response 215 to the replication engine 212, instead beginning the sequence by providing the replication request 216. In such scenarios, the replication engine 212 then determines the data blocks to be replicated based on the replication request 216 and creates that transfer map based on that determination. Then the replication engine 212 can determine the first CDE based on the replication request 216.

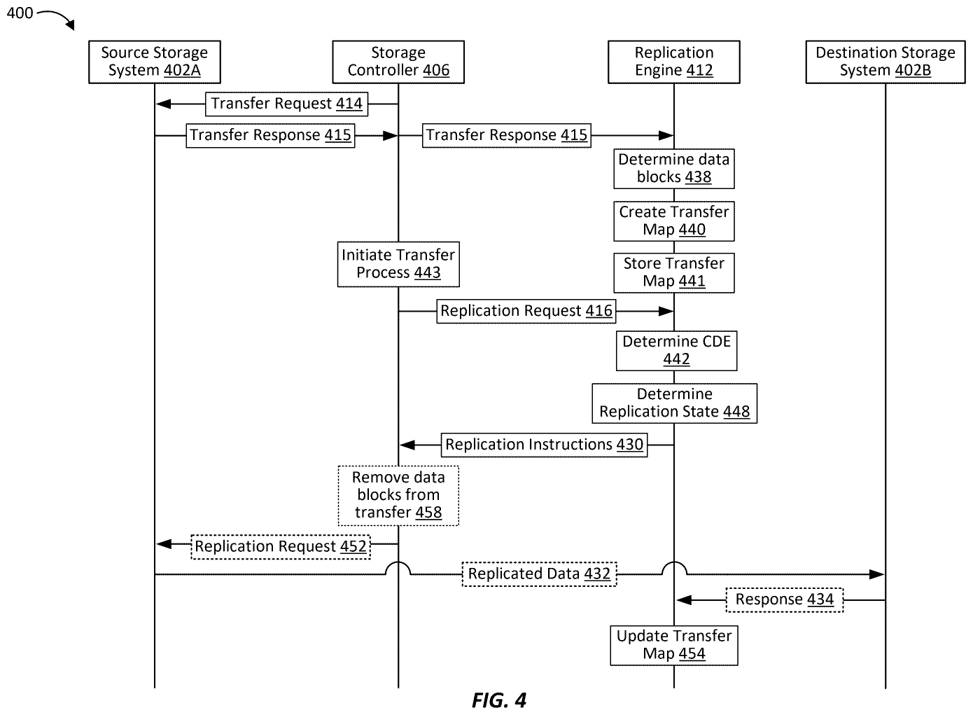

Referring now to FIG. 4, an example flow 400 for providing a replication engine 412 during a transfer process is illustrated, according to an embodiment herein. As shown, the flow 400 involves a transfer process, such as a WAFL Snap Diff operation to replicate any changed or modified data between a source storage system 402A and a destination storage system 402B, which may be the same or similar to the source storage system 102A and the destination storage system 102B, respectively.

To manage and orchestrate the transfer process, the flow 400 may include a storage controller 406, which may be the same or similar to the storage controller 106. To initiate the transfer process, the storage controller 106 may send a transfer request (414) to the source storage system 402A. As noted above, the transfer request (414) may be a Snap Diff request which causes the source storage system 402A to capture a snapshot of its data and compare the snapshot to a previous snapshot. Based on the comparison, the source storage system 402A may identify data blocks that have been added, deleted, or changed between the two snapshots (e.g., modified data blocks). The source storage system 402A may transmit a transfer response (415) to the storage controller 406 in which a list of the modified data blocks is included. The list may identify the modified data blocks by their respective block identifier (e.g., VVBNs or FFBNs).

The storage controller 406 may forward the transfer response (415) or the list provided in the transfer response (415) to the replication engine 412. The replication engine 412, which may be the same or similar to the replication engine 112 or 212, may determine the data blocks (438) that are to be replicated based on the list provided in the transfer response (415). In some embodiments, the replication engine 412 may determine whether there is a respective transfer map already created for the transfer process, such as by looking up one or more of the data blocks identified in the list on existing transfer maps. However, if the replication engine 412 determines that there is not an existing transfer map for this transfer process, the replication engine 412 may generate or create the transfer map (440).

The transfer map may be the same or similar to the transfer map 220. As such, upon creation, the replication engine 412 may save or store the transfer map 220 (441) to permeant memory, such as writing the transfer map 220 to disk. To create the transfer map 220, the replication engine 412 may generate an array including each of the data blocks identified in the transfer response list and a corresponding binary digit representing the replication state of a respective data block. For example, at the onset of the transfer process, the transfer map 220 may reflect a zero for each data block, thereby indicating that the respective data blocks have an unreplicated state.

At the storage controller 406, the transfer process may be initiated (443). For example, based on the transfer response (415), in particular the list of data blocks to be replicated during the transfer process, the storage controller 406 may generate one or more replication requests (416). The replication request (416) may be a data retrieval operation that instructs the source storage system 402A to read and retrieve one or more data blocks identified in the replication request (416). An example of a replication request (416) is a Snap Read request. As shown by flow 400, prior to transmitting the replication request (416) to the source storage system 402A to retrieve the requested data blocks, the storage controller 406 may query the replication engine 412 to determine whether or not all of the data blocks in the replication request (416) should be replicated.

The replication engine 412 may determine which data blocks are being requested in the replication request (416). Then based on the replication request (416), the replication engine 412 may determine a corresponding transfer map, such as the transfer map 220. Then, the replication engine 412 may determine, based on respective metadata, whether a first data block within the replication request (416) is part of a CDE. If the first data block is not part of a CDE, then the replication engine 412 may instruct the storage controller 406 to replicate the first data block as it is meant to be replicated in an uncompressed form. In some cases, this may mean the replication engine 412 merely skips over or filters out data blocks that are not part of a CDE. In other words, the replication engine 412 may analyze the data blocks identified in the replication request (416) and identify a subset of the data blocks that are part of a CDE.

Once the subset of data blocks that are part of CDE are identified, the replication engine 412 may determine what CDE a respective data block is part of (442). In an example, the replication engine 412 may parse the metadata associated with a respective CDE to determine what data blocks are included. In some cases, the metadata may also indicate whether the CDE is a contiguous or discontiguous CDE. As noted above, if the replication engine 412 identifies a CDE that is contiguous and that the data blocks forming the CDE are requested in a single replication request (416), and in some times requested in correct order, the replication engine 412 may instruct the storage controller 406 to proceed with replicating these CDEs. Again, this may include filtering CDEs having these conditions satisfied during the subsequent steps.

For CDEs that are discontiguous or fragmented, the replication engine 412 may determine a replication state (448) for the respective data blocks identified in the replication request (416). To determine the replication state (448), the replication engine 412 may perform a lookup on the transfer map to determine whether the respective data block has a replicated state or an unreplicated state.

Based on the replicated state for the respective data blocks, the replication engine 412 may generate and send replication instructions (430) to the storage controller 406. For example, for data blocks that have a replicated state, the instructions (430) may be to not replicate the data blocks again. Responsive to such instructions, the storage controller 406 may remove the data blocks from transfer or the replication request (458). In contrast, for data blocks that have an unreplicated state, the instructions (430) may be to replicate the entire corresponding CDE of which the respective data blocks are part of. Based on such instructions, the storage controller 406 may transmit the replication request (452) to the source storage system 402A to replicate the respective CDEs.

Responsive to receiving the replication request (452), the source storage system 402A may read and retrieve the corresponding data and send the replicated data (432) to the destination storage system 402B. If the destination storage system 402B successfully receives and writes the replicated data 432, the destination storage system 402B may provide a replication response (434) to the storage controller 406 and/or the replication engine 412. Responsive to receiving the replication response (434), the replication engine 412 may update the transfer map (454) to indicate that the data blocks that were replicated as part of the CDEs now have a replicated state.

As described above, in one embodiment the storage controller 406 does not provide the response 415 to the replication engine 412, instead only providing the replication request 416. In that case, the determination of the data blocks 418, creation of the transfer map 440 and storage of the transfer map 441 may occur after receipt of the replication request 416 and before determining the CDEs 442.

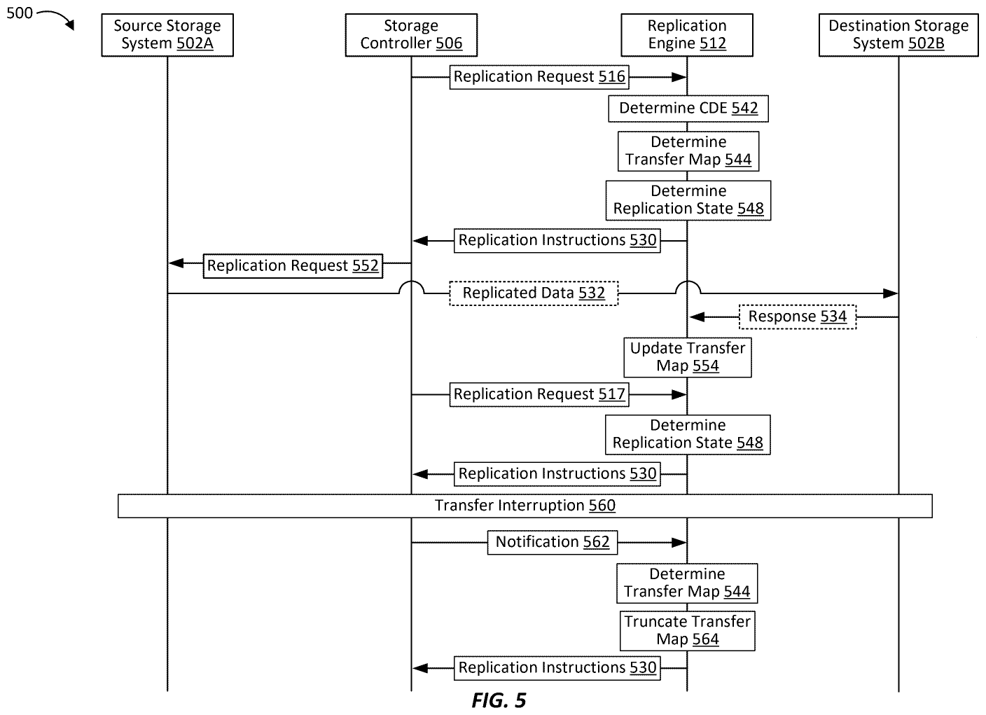

Referring now to FIG. 5, an example flow 500 in which a transfer interruption occurs during the replication process is illustrated, according to an embodiment herein. As shown, the flow 500 illustrates a storage controller 506, which may be the same or similar to the storage controller 406, transmits a replication request (516) to a replication engine 512, which may be the same or similar to the replication engine 412. Based on the replication request (516), the replication engine 512 may determine a CDE corresponding to a first data block (542). Based on the CDE, the replication engine 512 may determine a transfer map associated with the replication request (544). Then, based on the transfer map, the replication engine 512 may determine a replication state associated with the first data block (548).

In the illustrated flow 500, the replication engine 512 determines that the first data block has an unreplicated state. As such, the replication engine 512 may indicate that the first data block should be replicated by sending replication instructions (530) to the storage controller 506. As noted above, the replication instructions (530) may include instructions to replicate the entire CDE of which the first data block is part of, even if the remaining data blocks in the CDE are not identified in the replication request (516).

Responsive to receiving the instructions (530), the storage controller 506 may send a replication request (552) to the source storage system 502A for replicating the respective CDE. The source storage system 502A may then send replicated data 532 including the respective CDE to a destination storage system 502B, which may be the same or similar to the destination storage system 402B. Responsive to successfully receiving and writing the replicated data, the destination storage system 502B may send a replication response (534) to the replication engine 512. In turn, the replication engine 512 may update the transfer map (554) to indicate that the data blocks that form the CDE have a replicated state based on the successful replication.

At a later time, the storage controller 506 may send a subsequent replication request (517). Based on the subsequent replication request (517), the replication engine 512 may determine a replication state (548) for the data blocks identified in the replication request (517). Then, the replication engine 512 may generate and send replication instructions (530) to the storage controller 506 on whether or not to replicate the identified data blocks based on their respective replication state. However, before the storage controller 506 can initiate the subsequent replication request (517) based on the replication instructions (530) there may be a transfer interruption (560).

The transfer interruption (560) may be a system restart or abort due to a variety of factors. After the transfer interruption (560) occurs, the storage controller 506 may restart the transfer, such as by sending a notification (562) to the replication engine 512 to determine an existing transfer map associated with the restarting transfer (544). If the replication engine 512 identifies the transfer map associated with the restarting transfer map, the replication engine 512 may truncate the transfer map (564) to ensure that only valid, relevant data is retained.

Truncating the transfer map may mean that the replication engine 512 removes any incomplete or outdated information from the bitmap, effectively resetting it to reflect only the successfully completed portions of the previous transfer. Truncating the transfer map maintains the integrity of the transfer as it can prevent the use of potentially corrupted or partial metadata that could lead to errors in the replication process. Additionally, in the context of a SNIP Diff operation, a respective control plane may ensure that no new updates are issued while the current transfer is in an aborted or interrupted state, thereby avoiding any conflicts or inconsistencies. By truncating the transfer map, the replication engine 512 can reduce the risk of errors and ensure that the transfer can resume smoothly and accurately. Since the replication instructions (530) sent prior to the transfer interruption (560) did not result in a successful replication of respective data blocks, the replication engine 512, based on the truncated transfer map (564) may reissue the instructions (530) to the storage controller 506.

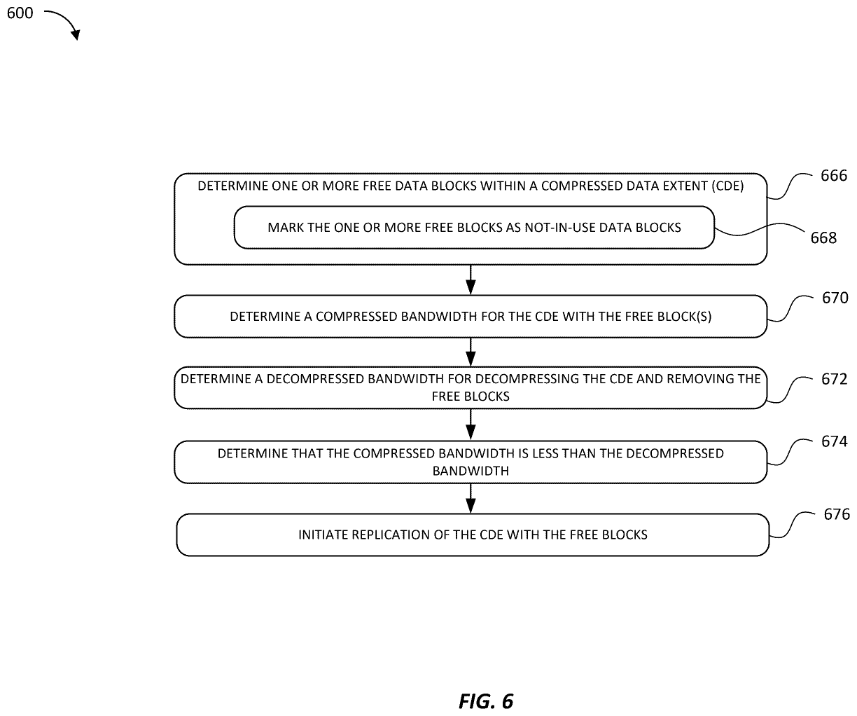

Referring now to FIG. 6, an example process 600 for handling free data blocks within a CDE is illustrated, according to an embodiment herein. The process 600 may be performed by a replication engine, such as the replication engine 212. As shown, during a transfer process, such as from a received replication request, the replication engine may determine one or more free data blocks within a CDE. A free data block is a block of storage that has been deallocated or marked as no longer in use within a file or volume, meaning it does not contain any active data. In some cases, the metadata associated with a free data block may indicate that it is free. As such, the replication engine may determine that a data block is free based on its respective metadata.

Free data blocks are typically formed through a process known as hole punching, where specific portions of a file are cleared or removed, effectively creating “holes” in the data. This operation allows the storage system, such as the source storage system 102A, to reclaim space that was previously allocated to these data blocks. Although these blocks remain part of the logical structure of the file, they no longer hold meaningful data and are not physically stored on disk. When free data blocks are part of a CDE, such as the CDE 110, the presence of these empty or deallocated blocks can result in the CDE being considered a partial CDE. A partial CDE is one where not all blocks within the extent contain valid data, with some blocks being placeholders for the free, unoccupied space. This partial nature can complicate replication or compression processes, as the CDE no longer represents a fully utilized, contiguous set of data blocks. As such, under conventional approaches, a partial CDE containing one or more free data blocks would be decompressed during a transfer process. However, as described below, the replication engine may handle partial CDEs containing one or more free data blocks such to preserve compression, both during the transfer and at the destination side.

Once the replication engine identifies one or more data blocks as free data blocks with a given CDE, the replication engine may mark the free data blocks as not-in-use data blocks (668). In some embodiments, marking the free data blocks as not-in-use data blocks may include modifying the metadata associated with the free data block with a fake block identifier. For example, VVBN of 1 may be selected to represent a fake block identifier for free data blocks since VVBN=1 is assigned to the superblock within certain storage systems, such as Flex Vol. A superblock is a critical structure that contains essential metadata about a respective volume, such as its size, layout, and status. Because of its importance and fixed role within the file system, VVBN=1 is reserved exclusively for the superblock and, as such, cannot be included in any CDE that holds user data.

Given that VVBN=1 is permanently assigned to the superblock and does not participate in regular data storage or compression, the replication engine may select it as a “safe” choice to represent a special or placeholder value, such as a FAKE_VVBN. A FAKE_VVBN to signify that the data block does not correspond to actual data. By using VVBN=1 for this purpose, the replication engine can leverage a block number that is already well-understood and guaranteed not to conflict with any real data blocks or CDEs, thus maintaining data integrity and avoiding unintended overlaps in the storage architecture.

A partial CDE containing one or more free data blocks—blocks that have been deallocated or marked as no longer in use—may still offer compression savings depending on the nature and extent of the remaining data blocks within the CDE. In cases where the active data blocks in the CDE are highly compressible, the overall compression ratio can remain favorable, allowing the system to store the data more efficiently despite the presence of free data blocks. The free data blocks, which do not contain actual data, can be compressed down to require minimal space, contributing to the overall savings. However, in other scenarios where the active data within the CDE is less compressible, where there are too many free data blocks, or where the free data blocks do not contribute to reducing the CDE's size, the CDE may not provide significant compression savings. In such cases, the inclusion of free data blocks may lead to a less efficient use of storage space and transmission bandwidth, as the overhead of maintaining the CDE could outweigh any minimal compression benefits.

To determine whether or not to maintain the CDE with the free data blocks therein, the replication engine may determine a compressed bandwidth for the CDE containing the free data block(s) (670). The replication may also determine a decompressed bandwidth for decompress the CDE and removing the free data blocks (672). In other words, the replication engine determines the size of the data of the CDE and the size of the data if the CDE is decompressed and the remaining active data blocks are transmitted in an uncompressed format. If the compressed bandwidth is less than the decompressed bandwidth (674), the replication engine may indicate that the CDE should be replicated with the free data blocks (676). However, if the replication engine determines the compressed bandwidth is greater than the decompressed bandwidth, then the replication engine may indicate that the CDE should be decompressed, the free data blocks should be removed, and the remaining active data blocks should be replicated in uncompressed form.

For CDEs containing free data blocks that are replicated, the blocks containing the not-in-use block identifiers may be stored as a compressed unit, thereby preserving the compressing savings on the destination side. However, when the CDE is later read or accessed by the system, the free data blocks within the extent may be recognized based on the not-in-use block identifier as unallocated or unnecessary, allowing the system to “release” these blocks, effectively treating them as if they do not contain any meaningful data. By releasing the free data blocks, the destination storage system can help optimize performance by avoiding the unnecessary processing of free data blocks and ensuring that only the active, relevant data is decompressed and used. As a result, the storage system maintains both storage efficiency and operational performance, leveraging the benefits of compression while dynamically managing the presence of free data blocks during data access.

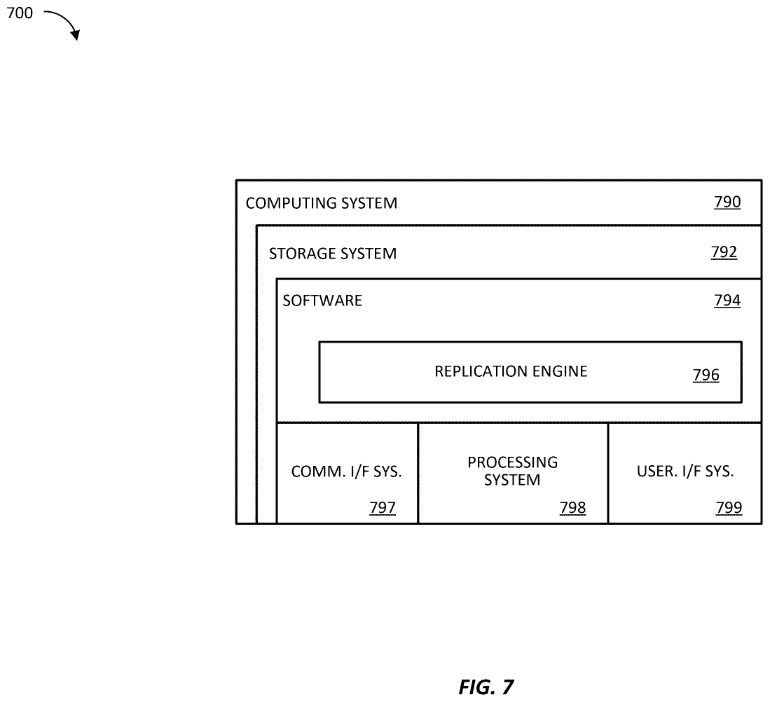

Referring now to FIG. 7, a diagram of a system 700 configured to implement one or more steps for providing a replication engine is described herein, according to an embodiment. The system 700 may be an example of an apparatus including a computing apparatus 790 that is representative of any system or collection of systems in which the various processes, systems, programs, services, and scenarios disclosed herein may be implemented. For example, computing apparatus 790 may be an example storage controller, such as the storage controller 106, or any of the subcomponents depicted in systems 100 or 200 of FIGS. 1 and 2, respectively. Examples of computing apparatus 790 include, but are not limited to, server computers, desktop computers, laptop computers, routers, switches, web servers, cloud computing platforms, and data center equipment, as well as any other type of physical or virtual server machine, physical or virtual router, container, and any variation or combination thereof.

Computing apparatus 790 may be implemented as a single apparatus, system, or device or may be implemented in a distributed manner as multiple apparatuses, systems, or devices. Computing apparatus 790 may include, but is not limited to, processing system 798, storage system 792, software 794, communication interface system 797, and user interface system 799. Processing system 798 may be operatively coupled with storage system 792, communication interface system 797, and user interface system 799.

Processing system 798 may load and execute software 794 from storage system 792. Software 794, stored in a non-transitory computer readable memory, may include replication engine process 796, which may be representative of one or more steps of the process or flows, as discussed with respect to the preceding figures. When executed by processing system 798, software 794 may direct processing system 798 to operate as described herein for at least the various processes, such as the processes 300 and 600, operational flows, such as flows 400 and 500, or any sequences discussed in the foregoing implementations. Computing apparatus 790 may optionally include additional devices, features, or functionality not discussed for purposes of brevity.

In some embodiments, processing system 798 may comprise a micro-processor and other circuitry that retrieves and executes software 794 from storage system 792. Processing system 798 may be implemented within a single processing device but may also be distributed across multiple processing devices or sub-systems that cooperate in executing program instructions. Examples of processing system 798 may include general purpose central processing units, graphical processing units, application specific processors, and logic devices, as well as any other type of processing device, combinations, or variations thereof.

Storage system 792 may comprise any memory device or computer readable storage media readable by processing system 798 and capable of storing software 794. Storage system 792 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 792 may also include computer readable communication media over which at least some of software 794 may be communicated internally or externally. Storage system 792 may be implemented as a single storage device but may also be implemented across multiple storage devices or sub-systems co-located or distributed relative to each other. Storage system 792 may comprise additional elements, such as a controller, capable of communicating with processing system 798 or possibly other systems.

Software 794 (including replication engine process 796 among other functions) may be implemented in program instructions that may, when executed by processing system 798, direct processing system 798 to operate as described with respect to the various operational scenarios, sequences, and processes illustrated herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 794 may include additional processes, programs, or components, such as operating system software, virtualization software, or other application software. Software 794 may also comprise firmware or some other form of machine-readable processing instructions executable by processing system 798.

In general, software 794 may, when loaded into processing system 798 and executed, transform a suitable apparatus, system, or device (of which computing apparatus 790 is representative) overall from a general-purpose computing system into a special-purpose computing system as described herein. Indeed, encoding software 794 on storage system 792 may transform the physical structure of storage system 792. The specific transformation of the physical structure may depend on various factors in different implementations of this description. Examples of such factors may include, but are not limited to, the technology used to implement the storage media of storage system 792 and whether the computer-storage media are characterized as primary or secondary storage, as well as other factors.

For example, if the computer readable storage media are implemented as semiconductor-based memory, software 794 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 797 may include communication connections and devices that allow for communication with other computing systems (not shown) over communication networks (not shown). Examples of connections and devices that together allow for inter-system communication may include network interface cards, antennas, power amplifiers, radio-frequency (RF) circuitry, transceivers, and other communication circuitry. The connections and devices may communicate over communication media to exchange communications with other computing systems or networks of systems, such as metal, glass, air, or any other suitable communication media.

Communication between the computing apparatus 790 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, which may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more memory devices or computer-readable storage medium(s) having computer readable program code embodied thereon.

The foregoing examples and descriptions are described herein in the context of systems and methods for providing a replication engine. Those of ordinary skill in the art will realize that these descriptions are illustrative only and are not intended to be in any way limiting. Reference is made in detail to implementations of examples as illustrated in the accompanying drawings. The same reference indicators are used throughout the drawings and the description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. That is, the foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in an embodiment,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all the following interpretations of the word: any of the items in the list, all the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub combinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112 (f) will begin with the words “means for” but use of the term “for” in any other context is not intended to invoke treatment under 35 U.S.C. § 112 (f). Accordingly, the applicant reserves the right to pursue additional claims after filing this application to pursue such additional claim forms, in either this application or in a continuing application.

### EXAMPLES

These illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this specification.

As used below, any reference to a series of examples is to be understood as a reference to each of those examples disjunctively (e.g., “Examples 1-4” is to be understood as “Examples 1, 2, 3, or 4”).

Example 1 is a computing apparatus comprising: a computer-readable storage medium; a replication engine comprising processor-executable instructions stored on the computer-readable storage medium; and one or more processors coupled to the computer-readable storage medium and configured to execute the processor-executable instructions to operate the replication engine, such that the processor-executable instructions, when executed by the one or more processors, direct the computing apparatus, to at least: receive the response to a transfer request between a source storage system and a destination storage system; determine a plurality of data blocks to be replicated from the source storage system to the destination storage system based on the transfer request; create a transfer map based on the plurality of data blocks, wherein the transfer map comprises a replication state for each respective data block within the plurality of data blocks; and initiate replication of a first compressed data extent (CDE) comprising a first subset of data blocks of the plurality of data blocks based on the replication state of at least one data block within the first subset of data blocks of the first CDE.

Example 2 is the computing apparatus of any previous or subsequent Example, wherein the processor-executable instructions when executed by the one or more processors, further direct the computing apparatus to: determine a replication request for replicating the at least one data block within the first subset of data blocks from the source storage system to the destination storage system; and determine, based on the transfer map, that the replication state of the at least one data block within the first subset of data blocks of the first CDE comprises an unreplicated state.

Example 3 is the computing apparatus of any previous or subsequent Example, wherein the processor-executable instructions when executed by the one or more processors, further direct the computing apparatus to: determine that the transfer request is completed; and delete the transfer map responsive to the transfer request being completed.

Example 4 is the computing apparatus of any previous or subsequent Example, wherein the processor-executable instructions, when executed by the one or more processors, further direct the computing apparatus to: determine a replication request for at least one data block within a second subset of data blocks of the plurality of data blocks, wherein a second CDE comprises the second subset of data blocks; determine, based on the transfer map, that the replication state for all of the data blocks of the at least one data block within the second subset of data blocks is a replicated state; and remove the replication request from the replication request based on the replicated state of all of the data blocks of the at least one data blocks within the second subset of data blocks.

Example 5 is the computing apparatus of any previous or subsequent Example, wherein: the processor-executable instructions to initiate replication of the first CDE comprising the first subset of data blocks of the plurality of data blocks based on the replication state of the at least one data block within the first subset of data blocks of the first CDE, when executed by the one or more processors, further direct the computing apparatus to include the first CDE in the replication request; and wherein the processor-executable instructions when executed by the one or more processors, further direct the computing apparatus to: receive a replication response from the destination storage system responsive to successfully replication of the first CDE; and update the replication state associated with the first subset of data blocks within the transfer map to a replicated state based on the replication response.

Example 6 is the computing apparatus of any previous or subsequent Example, wherein the processor-executable instructions when executed by the one or more processors, further direct the computing apparatus to: perform a lookup of the at least one data block within the first subset of data blocks in the transfer map; and determine, based on the lookup, that the replication state of the at least one data block within the first subset of data blocks is an unreplicated state.

Example 7 is the computing apparatus of any previous or subsequent Example, wherein the processor-executable instructions, when executed by the one or more processors, further direct the computing apparatus to: responsive to replication of the first CDE from the source storage system to the destination storage system, update the replication state of each data block within the first subset of data blocks on the transfer map to a replicated state.

Example 8 is a method comprising: determining, by a replication engine, a replication request to replicate one or more data blocks from a source storage system to a destination storage system; determining, by the replication engine, a first compressed data extent (CDE) comprising a first subset of data blocks based on the replication request, wherein the first subset of data blocks comprises the one or more data blocks; determining, by the replication engine, a transfer map associated with the replication request; determining, by the replication engine, a replication state associated with the one or more data blocks based on the transfer map; and initiating, by the replication engine, replication of the first CDE from the source storage system to the destination storage system based on the replication state associated with the one or more data blocks.

Example 9 is the method of any previous or subsequent Example, wherein the method further comprises: determining, by the replication engine, a transfer request between the source storage system and the destination storage system; determining, by the replication engine, a plurality of data blocks to be replicated during a transfer between the source storage system and the destination storage system based on a transfer response to the transfer request, wherein the plurality of data blocks comprise the one or more data blocks; and creating, by the replication engine, the transfer map based on the transfer response, wherein the transfer map comprises the replication state for each respective data block within the plurality of data blocks.

Example 10 is the method of any previous or subsequent Example, wherein determining, by the replication engine, the replication state of the one or more data blocks based on the transfer map comprises: performing, by the replication engine, a lookup of the one or more data blocks in the transfer map; and determining, by the replication engine, that the replication state for the one or more data blocks comprises an unreplicated state.

Example 11 is the method of any previous or subsequent Example, wherein: the method further comprises determining, by the replication engine, that the first subset of data blocks within the first CDE are discontinuous; and determining, by the replication engine, the transfer map associated with the replication request based on the first subset of data blocks being discontinuous.

Example 12 is the method of any previous or subsequent Example, wherein the transfer map comprises a bitmap.

Example 13 is the method of any previous or subsequent Example, wherein the method further comprises: responsive to replication of the first CDE from the source storage system to the destination storage system, updating, by the replication engine, the replication state associated with the first subset of data blocks in the transfer map to a replicated state.

Example 14 is the method of any previous or subsequent Example, wherein the method further comprises: detecting, by the replication engine, an interruption to an on-going transfer of data blocks between the source storage system and the destination storage system, wherein the on-going transfer comprises the replication request; and truncating, by the replication engine, the transfer map based on the interruption.

Example 15 is a computer-readable storage medium comprising processor-executable instructions configured to cause one or more processors to: determine, by a replication engine, a replication request to replicate one or more data blocks from a source storage system to a destination storage system during a transfer process, wherein the one or more data blocks are compressed in a first compressed data extent (CDE); determine, by the replication engine, a transfer map associated with the transfer process; determine, by the replication engine, a replication state associated with the one or more data blocks based on the transfer map; and initiate, by the replication engine, replication of the first CDE from the source storage system to the destination storage system based on the replication state associated with the one or more data blocks.

Example 16 is the computer-readable storage medium of any previous or subsequent Example, wherein: the first CDE comprises a plurality of data blocks; the processor-executable instructions to initiate, by the replication engine, replication of the first CDE from the source storage system to the destination storage system based on the replication state associated with the one or more data blocks cause the one or more processors to further execute processor-executable instructions stored in the computer-readable storage medium to instruct, by the replication engine, to include the first CDE in the replication request; and the processor-executable instructions cause the one or more processors to further execute processor-executable instructions stored in the computer-readable storage medium to: receive, from the destination storage system, a replication response indicating successful replication of the first CDE; and update the replication state in the transfer map for the plurality of data blocks in the first CDE to a replicated state based on the replication response.

Example 17 is the computer-readable storage medium of any previous or subsequent Example, wherein the first CDE comprises a plurality of data blocks, and wherein the processor-executable instructions cause the one or more processors to further execute processor-executable instructions stored in the computer-readable storage medium to: determine, by the replication engine, a first data block within the plurality of data blocks of the first CDE is a free data block; and mark, by the replication engine, the first data block as not-in-use data block.

Example 18 is the computer-readable storage medium of any previous or subsequent Example, wherein the first CDE comprises a plurality of data blocks, and wherein the processor-executable instructions cause the one or more processors to further execute processor-executable instructions stored in the computer-readable storage medium to: determine, by the replication engine, one or more data blocks within the plurality of data blocks of the first CDE comprise free data blocks; determine, by the replication engine, that maintaining the CDE for replication comprises less bandwidth than decompressing the CDE to remove the one or more data blocks comprising the free data blocks; and initiate, by the replication engine, the replication of the first CDE comprising the free data blocks from the source storage system to the destination storage system.

Example 19 is the computer-readable storage medium of any previous or subsequent Example, wherein the processor-executable instructions cause the one or more processors to further execute processor-executable instructions stored in the computer-readable storage medium to: determine, by the replication engine, a transfer request for the transfer process between the source storage system and the destination storage system; create, by the replication engine, the transfer map based on the transfer request, wherein the transfer map comprises a replication state for a respective data block within a plurality of data blocks being replicated during the transfer process; and store, by the replication engine, the transfer map in persistent memory for the duration of the transfer process.

Example 20 is the computer-readable storage medium of any previous or subsequent Example, wherein the processor-executable instructions cause the one or more processors to further execute processor-executable instructions stored in the computer-readable storage medium to: determine, by the replication engine, a second replication request to replicate a second subset of data blocks from the source storage system to the destination storage system, wherein the second subset of data blocks are compressed in a second CDE; determine, by the replication engine, a replication state associated with the second subset of data blocks in the second CDE based on the transfer map; and remove, by the replication engine, the second subset of data blocks from the transfer process between the storage system to the destination storage system based on the replication state of the second subset of data blocks.

1. A computing apparatus comprising:
a non-transitory computer-readable storage medium storing processor-executable instructions stored on the computer-readable storage medium; and
one or more processors coupled to the computer-readable storage medium and configured to execute the stored processor-executable instructions, such that the processor-executable instructions, when executed by the one or more processors, direct the computing apparatus, to at least:
receive a response to a transfer request between a source storage system and a destination storage system;
determine a plurality of data blocks to be replicated from the source storage system to the destination storage system based on the response to the transfer request;
create a transfer map based on the plurality of data blocks, wherein the transfer map comprises a replication state for each respective data block within the plurality of data blocks; and
identify, from the plurality of data blocks, at least one data block that is a member of a first compressed data extent (CDE) comprising a first subset of data blocks of the plurality of data blocks;
determine, from the transfer map, that the replication state of the at least one data block is an unreplicated state; and
initiate replication of the first subset of data blocks of the first CDE in compressed form based on the replication state of the at least one data block within the first subset of data blocks of the first CDE, regardless of the replication state of other data blocks in the first CDE.

2. The computing apparatus of claim 1, wherein the processor-executable instructions when executed by the one or more processors, further direct the computing apparatus to:
receive a replication request for replicating the at least one data block within the first subset of data blocks from the source storage system to the destination storage system;
determine that the at least one data block comprises a portion of the first CDE;
determine, based on the transfer map, that the replication state of the at least one data block within the first subset of data blocks of the first CDE comprises an unreplicated state; and
initiate the replication of the entire first CDE.

3. The computing apparatus of claim 1, wherein the processor-executable instructions when executed by the one or more processors, further direct the computing apparatus to:
determine that the transfer request is completed; and
delete the transfer map responsive to the transfer request being completed.

4. The computing apparatus of claim 1, wherein the processor-executable instructions, when executed by the one or more processors, further direct the computing apparatus to:
receive a replication request for at least one data block within a second subset of data blocks of the plurality of data blocks, wherein a second CDE comprises the second subset of data blocks;
determine, based on the transfer map, that the replication state for all of the data blocks of the at least one data block within the second subset of data blocks is a replicated state; and
remove the replication request from the replication request based on the replicated state of all of the data blocks of the at least one data blocks within the second subset of data blocks.

5. The computing apparatus of claim 1, wherein:
the processor-executable instructions to initiate replication of the first subset of the data blocks of the first CDE in compressed form based on the replication state of the at least one data block within the first subset of data blocks of the first CDE, when executed by the one or more processors, further direct the computing apparatus to include the first CDE in a replication request; and
wherein the processor-executable instructions when executed by the one or more processors, further direct the computing apparatus to:
receive a replication response from the destination storage system responsive to successfully replication of the first CDE; and
update the replication state associated with the first subset of data blocks within the transfer map to a replicated state based on the replication response.

6. The computing apparatus of claim 1, wherein the processor-executable instructions when executed by the one or more processors, further direct the computing apparatus to:
perform a lookup of the at least one data block within the first subset of data blocks in the transfer map; and
determine, based on the lookup, that the replication state of the at least one data block within the first subset of data blocks is an unreplicated state.

7. The computing apparatus of claim 1, wherein the processor-executable instructions, when executed by the one or more processors, further direct the computing apparatus to:
responsive to replication of the first CDE from the source storage system to the destination storage system, update the replication state of each data block within the first subset of data blocks on the transfer map to a replicated state.

8. A method comprising:
receiving, by a replication engine, a replication request to replicate one or more data blocks from a source storage system to a destination storage system;
determining, by the replication engine, a first compressed data extent (CDE) comprising a first subset of data blocks based on the replication request, wherein the first subset of data blocks comprises the one or more data blocks;
determining, by the replication engine, a transfer map associated with the replication request;
determining, by the replication engine, that a replication state associated with the one or more data blocks is an unreplicated state based on the transfer map; and
initiating, by the replication engine, replication of the first subset of data blocks of the first CDE in compressed form from the source storage system to the destination storage system based on the replication of the one or more data blocks, regardless of the replication state of the other data blocks in the first CDE.

9. The method of claim 8, wherein the method further comprises:
receiving, by the replication engine, a response to a transfer request between the source storage system and the destination storage system;
determining, by the replication engine, a plurality of data blocks to be replicated during a transfer between the source storage system and the destination storage system based on the response to the transfer request, wherein the plurality of data blocks comprise the one or more data blocks; and
creating, by the replication engine, the transfer map based on the response to the transfer request, wherein the transfer map comprises the replication state for each respective data block within the plurality of data blocks.

10. The method of claim 8, wherein determining, by the replication engine, the replication state of the one or more data blocks based on the transfer map comprises:
performing, by the replication engine, a lookup of the one or more data blocks in the transfer map; and
determining, by the replication engine, that the at least one data block comprises a portion of the first CDE.

11. The method of claim 8, wherein:
the method further comprises determining, by the replication engine, that the first subset of data blocks within the first CDE are discontinuous; and
determining, by the replication engine, the transfer map associated with the replication request based on the first subset of data blocks being discontinuous.

12. The method of claim 8, wherein the transfer map comprises a bitmap.

13. The method of claim 8, wherein the method further comprises:
responsive to an indication of successful replication of the first CDE from the source storage system to the destination storage system, updating, by the replication engine, the replication state associated with the first subset of data blocks in the transfer map to a replicated state.

14. The method of claim 8, wherein the method further comprises:
detecting, by the replication engine, an interruption to an on-going transfer of data blocks between the source storage system and the destination storage system, wherein the on-going transfer comprises the replication request; and
truncating, by the replication engine, the transfer map based on the interruption.

15. A non-transitory computer-readable storage medium comprising processor-executable instructions configured to cause one or more processors to:
receive, by a replication engine, a replication request to replicate one or more data blocks from a source storage system to a destination storage system during a transfer process, wherein the one or more data blocks are compressed in a first compressed data extent (CDE);
determine, by the replication engine, a transfer map associated with the transfer process;
determine, by the replication engine, that a replication state associated with the one or more data blocks is an unreplicated state based on the transfer map; and
initiate, by the replication engine, alterations to the replication of the first CDE in compressed form from the source storage system to the destination storage system based on the replication state associated with the one or more data blocks, regardless of the replication state of the other data blocks in the first CDE.

16. The non-transitory computer-readable storage medium of claim 15, wherein:
the first CDE comprises a plurality of data blocks,
the first CDE is included in a replication request provided to a destination storage system, and
the processor-executable instructions cause the one or more processors to further execute processor-executable instructions stored in the computer-readable storage medium to:
receive a replication response indicating successful replication of the first CDE; and
update the replication state in the transfer map for the plurality of data blocks in the first CDE to a replicated state based on the replication response.

17. The non-transitory computer-readable storage medium of claim 15, wherein the first CDE comprises a plurality of data blocks, and wherein the processor-executable instructions cause the one or more processors to further execute processor-executable instructions stored in the computer-readable storage medium to:
determine, by the replication engine, a first data block within the plurality of data blocks of the first CDE is a free data block; and
mark, by the replication engine, the first data block as not-in-use data block.

18. The non-transitory computer-readable storage medium of claim 15, wherein the first CDE comprises a plurality of data blocks, and wherein the processor-executable instructions cause the one or more processors to further execute processor-executable instructions stored in the computer-readable storage medium to:
determine, by the replication engine, one or more data blocks within the plurality of data blocks of the first CDE comprise free data blocks;
determine, by the replication engine, that maintaining the CDE for replication comprises less bandwidth than decompressing the CDE to remove the one or more data blocks comprising the free data blocks; and
instruct, by the replication engine, the inclusion of the first CDE comprising the free data blocks in the replication request from the source storage system to the destination storage system.

19. The non-transitory computer-readable storage medium of claim 15, wherein the processor-executable instructions cause the one or more processors to further execute processor-executable instructions stored in the computer-readable storage medium to:
receive, by the replication engine, a response to a transfer request for the transfer process between the source storage system and the destination storage system;
create, by the replication engine, the transfer map based on the response to the transfer request, wherein the transfer map comprises a replication state for a respective data block within a plurality of data blocks being replicated during the transfer process; and
store, by the replication engine, the transfer map in persistent memory for the duration of the transfer process.

20. The non-transitory computer-readable storage medium of claim 15, wherein the processor-executable instructions cause the one or more processors to further execute processor-executable instructions stored in the computer-readable storage medium to:
receive, by the replication engine, a second replication request to replicate a second subset of data blocks from the source storage system to the destination storage system, wherein the second subset of data blocks are compressed in a second CDE;
determine, by the replication engine, a replication state associated with the second subset of data blocks in the second CDE based on the transfer map; and
instruct, by the replication engine, the removal of the second subset of data blocks from the transfer process between the storage system to the destination storage system based on the replication state of the second subset of data blocks.
